(19) United States
(12) Patent Application Publication
(10) Pub. No.: US 2007/0197330 A1
(43) Pub. Date: Aug. 23, 2007

(54) Method for producing a rocker pressure member, and stamping apparatusw

(75) Inventors: Martin Vornehm, Buhl (DE); Andreas Triller, Buhl (DE); Werner Gruca, Memprectshofen (DE); Felix Schmitz, Beinheim (FR)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/645,089

(22) Filed: Dec. 21, 2006

Related U.S. Application Data
(60) Provisional application No. 60/752,702, filed on Dec. 21, 2005.

(51) Int. Cl. F16G 13/04; F16G 5/16; F16G 1/21

(52) U.S. Cl. 474/215; 474/245

(57) ABSTRACT

A method for producing a rocker pressure member forming part of a chain hinge joint for a plate-link chain. A shaped wire is embossed along at least a predetermined segment in the longitudinal direction, and then a separation is made at that segment. A stamping apparatus for producing a rocker pressure member from a shaped wire is provided, with a housing which includes a lower housing half as a die and an upper housing half to guide at least one stamping die for embossing the shaped wire.

### BACKGROUND OF THE INVENTION

1. Field of the Invention

The present invention relates to a method for producing a rocker pressure member of a chain hinge joint, in particular for a CVT chain. In addition, the present invention relates to a stamping apparatus for producing a rocker pressure member, and furthermore to a rocker pressure member for a chain hinge joint, in particular for a CVT chain.

2. Description of the Related Art

From motor vehicle technology, for example, a plate-link chain for a belt-driven conical pulley transmission is known. The plate-link chain is also referred to as a CVT chain, and functions as an endless torque-transmitting means for transmitting torque for a CVT transmission. A plate-link chain of that type includes link plates that are positioned one after the other in a predetermined pattern in a number of rows that are positioned side-by-side in reference to the longitudinal direction of the plate-link chain. Each plate has an opening into which extend two pairs of rocker members in the form of pins. Thus, two adjacent plates are hingedly linked with each other as a chain hinge joint by a pair of rocker pressure members. Each pair of rocker pressure members has two rocker pressure members. The rocker pressure members are supported in the longitudinal direction of the plate-link chain with their sides that face away from each other against the inner edge of the opening of the respective plate at contact surfaces. Bending of the plate-link chain is made possible by the fact that the rocker pressure members of a chain hinge joint mutually rotate. The rocker pressure members thereby roll against each other on the rolling surfaces that are located on the sides facing each other.

An object of the present invention is to provide a method for producing a rocker pressure member and a stamping apparatus for producing a rocker pressure member, as well as a rocker pressure member with which it is possible to relieve the link plates of a plate-link chain when transmitting torque.

### SUMMARY OF THE INVENTION

In accordance with one aspect of the present invention, a method is provided for producing a rocker pressure member of a chain hinge joint for a plate-link chain, in particular for a CVT plate-link chain or the like. A wherein a shaped wire or the like is embossed along at least a predetermined segment in the longitudinal direction and then a separation is made at that segment. Through the embossing or shaping of the wire or of the later rocker pressure member in accordance with the invention, the profiling and hence the thickness of the rocker pressure member can change along a predetermined segment. That shaping makes it possible to achieve a relief in a beneficial way when using the thereby-produced rocker pressure member as a chain hinge joint in a plate-link chain, for example in a CVT plate-link chain, and in particular in edge regions of each plate. The rocker pressure members produced in accordance with the invention enable greater elongation, in particular of the edge plate of a plate-link chain, which contributes in an advantageous way to an increase in strength. With the method in accordance with the invention, especially economical rocker pressure members for a plate-link chain are thus produced, and by an especially reliable process.

However, in addition to the profiling of the shaped wire in the form of a rocker pressure member that is provided in accordance with the invention, other shaping possibilities are also usable. For example, a predetermined segment of the shaped wire could likewise be shaped by extreme stretching, for example. However, that type of shaping comes up against limits of processing capability. In particular, in that case the plates of the plate-link chains could flow and tear. Furthermore, production with such a form of shaping is relatively expensive and labor-intensive. Thus, the embossing of the shaped wire is especially advantageous in every respect.

Within the scope of an advantageous embodiment of the method in accordance with the invention, provision can be made for every separated shaped wire to be formed as a rocker pressure member with at least one embossed rolling surface for rolling on a corresponding rolling surface of another rocker pressure member. By embossing the corresponding rolling surfaces of two rocker pressure members of a pair of rocker pressure members to hingedly connect two plates of a plate-link chain, an especially favorable force curve can be achieved, in particular at an edge plate of the plate-link chain.

In accordance with a next refinement of the invention, provision can also be made for every separated shaped wire to be formed as a rocker pressure member with at least one embossed contact surface for contacting an inside edge of an opening of a link plate. Along with the embossing of the rolling surfaces, it is also conceivable for the contact surfaces also or exclusively to be embossed. The embossed contact surfaces serve to provide optimal contact on the inside edge of the opening of a link plate. Here too, preferred radii can be achieved through embossing those segments of the rocker pressure member in accordance with the invention.

In the method in accordance with the invention, it is especially advantageous if a forming or embossing is carried out on a non-hardened material, so that the embossed rocker pressure member is hardened only after being separated. In that way, the wire profile can be taken from a coil as an endless wire, and the embossing takes place first, with the hardening to be performed only after a certain portion of the shaped wire has been cut off. That makes it possible to save an additional manipulation of the parts, because the shaping has already been done on the endless wire.

The embossing or shaping is done in accordance with the invention in such a way that very high precision of the degree of shaping is made possible by a force controller. That is in contrast with the otherwise usual distance control systems by stops on forming dies. In addition, in the shaping in accordance with the invention internal stresses are produced in the rocker pressure member or on the shaped wire, by which the breaking strength of the rocker pressure member is further increased, similar to the way the strength of the plates increases when the chain is stretched.

The object in accordance with the invention is also achieved by a stamping apparatus for producing a rocker pressure member of a chain hinge joint from a shaped wire. Accordingly, a stamping apparatus is provided, in particular for performing the aforementioned procedure, which includes a housing that has a lower housing half as a die and an upper housing half to guide a stamp for embossing the shaped wire. Preferably the stamping apparatus in accordance with the invention can be used to stamp or emboss a rocker pressure member as described above.

To make the shaping in accordance with the invention possible with the provided stamping apparatus, the lower housing half of the stamping apparatus in accordance with the invention can have a channel, or the like, in which the shaped wire can be received and guided, for example as an endless wire.

In that connection, an advantageous embodiment provides that the channel of the lower housing half has at least one recess for forming at least one contact surface on the shaped wire. Preferably, however, there can be a plurality of recesses for contact surfaces, fitted to guide the shaped wire in the channel. Furthermore, the channel can have a free passage, or the like, to receive the material that is displaced by the stamping operation. The free passage can preferably be opposite the rolling surface that is to be stamped. Other possible arrangements of the free passage and of the recesses for the contact surfaces are also possible.

In another embodiment of the invention, the upper housing half of the stamping apparatus in accordance with the invention can have a guide that is oriented approximately perpendicular to the channel or the like for the stamping die, for example. That achieves optimal guidance of the stamping die when it is pressed downward onto the rolling surface that is being stamped. The stamping die itself can have a convex stamping surface with an approximately rectangular basic shape. Other design shapes of the stamping surface are also conceivable.

In accordance with a refinement of the invention, the convex stamping surface can have a predetermined inclination in order to achieve a preferred shape of the surface being stamped or the rolling surface on the rocker pressure member. Preferably a stamping die with a mirror-image-symmetrical stamping surface for stamping two rolling surfaces in just one stamping run can have a inclination from the central mirror axis to the respective edge in which the center region is about 0.05 to 0.01 mm higher than the respective edge. Other patterns of the inclination are also conceivable.

In addition to the continuous feeding of an endless wire profile, the stamping apparatus in accordance with the invention can include a severing unit with which a predetermined length segment of the stamped shaped wire is cut off as a rocker pressure member, for example, so that the individual rocker pressure members can be collected in a receiving container. Those individual rocker pressure members can then be hardened together in an especially simple manner.

Preferably the separation of the shaped wire is performed on each of the stamped segments. In particular with a stamping die that has a double stamping surface, with which two stamped segments are formed in one stamping procedure, the separation or cutoff can be performed approximately in the center, so that a stamped section or rolling surface is provided at one end of each rocker pressure member.

In addition, the present invention also provides a rocker pressure member of a chain hinge joint for a plate-link chain, in particular for a CVT plate-link chain. The rocker pressure member in accordance with the invention can be provided as a chain hinge joint in an opening of a link plate of the plate-link chain, or it can extend into that opening. Two rocker pressure members then form a pair of rocker pressure members as a chain hinge joint. The opposite back sides of the rocker pressure members of the pair of rocker pressure members form the contact surfaces for contact with the inside edge of the link plate opening, while rolling surfaces for rolling against each other are provided in addition on the facing sides of the rocker pressure members of the pair of rocker pressure members.

In accordance with the invention, at least one of those rolling surfaces of each rocker pressure member is embossed, in order to obtain the previously described advantages. Through that provided embossing of at least the rolling surfaces, the relative depth between the embossed rolling surface and a contact surface of the rocker pressure member in the longitudinal direction is changed or reduced.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic side view of one possible embodiment of a stamping apparatus in accordance with the invention for carrying out a method for producing a rocker pressure member;

FIG. 2 is a perspective view of a part of the stamping apparatus for producing the rocker pressure member;

FIG. 3 is an enlarged fragmentary view of a lower housing half of the stamping apparatus;

FIG. 4 is a perspective view of a stamping die of the stamping apparatus; and

FIG. 5 is an enlarged fragmentary view of two rocker pressure members in accordance with the invention as a pair of rocker pressure members positioned in an opening of a link plate of a plate-link chain.

### DESCRIPTION OF THE PREFERRED EMBODIMENTS

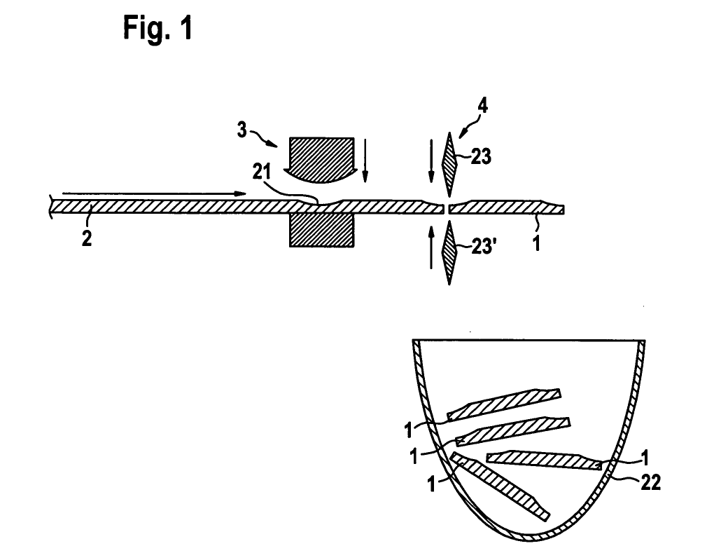

FIG. 1 shows a schematic side view of one possible embodiment of a stamping apparatus for producing a rocker pressure member from a shaped wire 2, with which the individual procedural steps of the method that is also provided for producing the rocker pressure member 1 are carried out.

In the method in accordance with the invention for producing a rocker pressure member 1, a shaped wire 2, whose direction of motion is indicated by an arrow, is fed to the stamping apparatus 3, in order to be embossed by the stamping apparatus 3 at a predetermined segment 21. After the embossing of shaped wire 2, shaped wire 2 is cut off by means of a severing unit 4 in the middle of the stamped segments 21, so that the individual rocker pressure members 1 can be collected as blanks in the form of bulk material in a receiving container 22. The severing unit 4 is indicated only schematically in FIG. 1 by two knives 23, 23′ that are movable toward each other, the directions of motion being indicated by arrows. Other separating or cutoff tools can also be used.

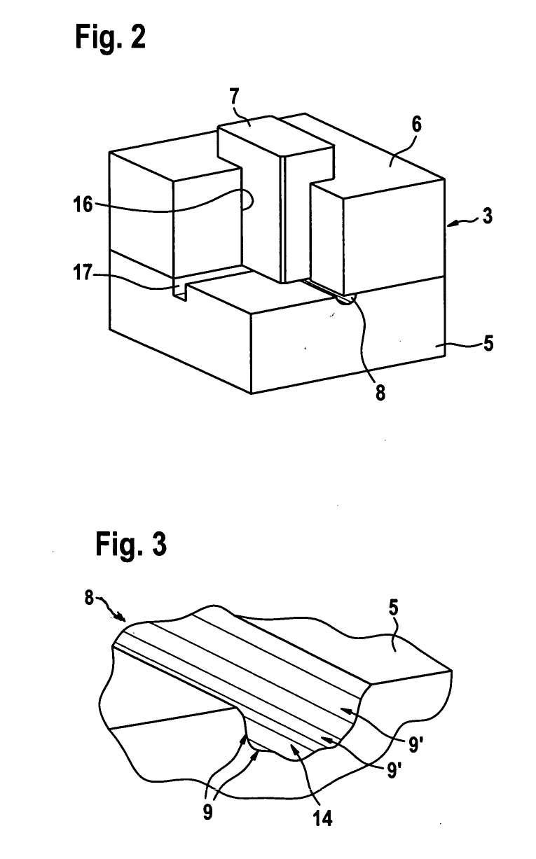

FIG. 2 shows a detailed view of a possible embodiment of the stamping apparatus 3. Stamping apparatus 3 in accordance with the invention includes a housing with a lower housing half 5 and an upper housing half 6. Lower housing half 5 functions as a bottom die, while upper housing half 6 serves to guide a stamping die 7 with which shaped wire 2 is embossed to produce a rocker pressure member 1. Lower housing half 5 includes a channel 8, which is produced in approximately semicircular form in the top of lower housing half 5, and which faces upper housing half 6. Channel 8 receives shaped wire 2, made from endless material, and guides it to the stamping die 7.

Channel 8 is shown in detail in FIG. 3. It can be seen from that view that channel 8 has opposed recesses 9, 9′ in its side regions, which are provided for forming contact surfaces 10, 10′ on rocker pressure members 1, 1′ (see FIG. 5). Those contact surfaces 10, 10′ serve on rocker pressure members 1, 1′ to contact an inner edge 11 of an opening 12 of a link plate 13 of a plate-link chain 19.

Furthermore, channel 8 includes in its lower are, oriented approximately toward the center, a free passage 14 for receiving the material of the shaped wire 2 that is displaced in the stamping or embossing step, in order to provide appropriate rolling surfaces 15 on rocker pressure member 1 of a pair of rocker pressure members, and in order to ensure rolling of the rocker pressure members 1, 1′ of a pair of rocker pressure members on mutually facing rolling surfaces 15, 15′.

To emboss the rolling surfaces 15, 15′ of each rocker pressure members 1, 1′, stamping apparatus 3 includes stamping die 7, which is received in guide 16 of upper housing half 6, approximately perpendicular to channel 8. To adjust the shaped wire 2 or the stamping die 7 for the embossing, lower housing half 5 has an auxiliary channel 17 which extends perpendicular to channel 8.

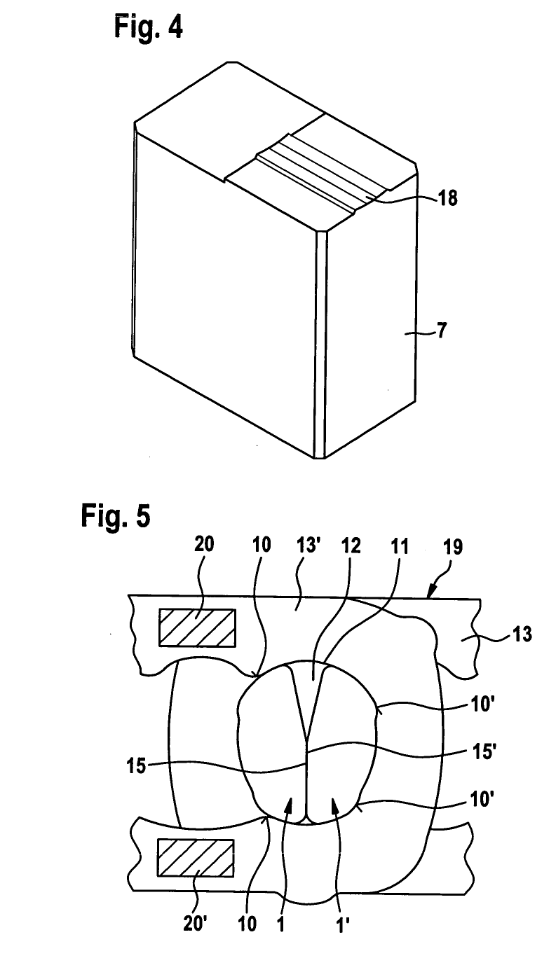

FIG. 4 shows one possible embodiment of stamping die 7 of stamping apparatus 3 with a stamping surface 18 divided into two parts. Since stamping surface 18 is mirror-image symmetrical, only one half of stamping surface 18 is shown in FIG. 4. In that embodiment raised stamping surface 18 has an approximately rectangular basic shape. Raised stamping surface 18 is formed with an inclination, in order to obtain the desired shape of rolling surfaces 15, 15′ on rocker pressure members 1, 1′. The inclination is formed so that the center, i.e., the axis of symmetry, is approximately 0.05 to 0.01 mm higher than the respective edge. Other design shapes of stamping surface 18 are also possible.

FIG. 5 shows a fragmentary view of a plate-link chain with two link plates 13, 13′ that are hingedly connected by a pair of rocker pressure members composed of rocker pressure members 1, 1′. The two rocker pressure members 1, 1′ of the pair of rocker pressure members are carried in an opening 12, and their contact surfaces are in contact with the inner edge 11 of opening 12. It is clear from that view that the mutually facing sides of rocker pressure members 1, 1′ roll against each other on their rolling surfaces 15, 15′ when plate-link chain 19 bends. Strain gauges 20, 20′ are provided to record the force pattern within the link plate 13.

It has been found that by embossing the rolling surfaces 15, 15′ of each rocker pressure member 1, 1′ a relief is made possible, in particular at the edge of a plate-link chain. The internal stresses produced in each rocker pressure member when the rolling surfaces 15, 15′ are embossed result in an increase in the breaking strength, whereby the overall strength of a plate-link chain 19 with the rocker pressure members 1, 1′ in accordance with the invention can be increased.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for producing a rocker pressure member of a chain hinge joint for a plate-link chain, said method comprising the steps of: embossing a shaped wire along at least predetermined spaced segments in a longitudinal direction of the wire, and severing the segments from the wire by cutting the wire at embossed regions.

2. A method in accordance with claim 1, including the step of forming the severed shaped wire segments as rocker pressure members having at least one embossed rolling surface for rolling on a corresponding rolling surface of a complementary rocker pressure member.

3. A method in accordance with claim 1, including the step of forming the severed shaped wire segments as rocker pressure members having at least one embossed rolling surface for contacting an inner edge of an opening in a link plate for a chain.

4. A method in accordance with claim 2, including the step of hardening the embossed rocker pressure members after having been cut off.

5. A stamping apparatus for producing a rocker pressure member of a chain hinge joint from a shaped wire, said apparatus comprising: a housing that includes a lower housing half defining a die, and an upper housing half including a guide for guiding least one stamping die for embossing the shaped wire.

6. A stamping apparatus in accordance with claim 5, wherein the lower housing half includes a channel for receiving and guiding a shaped wire.

7. A stamping apparatus in accordance with claim 6, wherein the channel includes at least one recess for forming at least one contact surface on the shaped wire.

8. A stamping apparatus in accordance with claim 6, wherein the channel includes at least one free passage to receive material of the shaped wire that is displaced during a stamping operation.

9. A stamping apparatus in accordance with claim 5, wherein the guide includes a guide surface that is oriented substantially perpendicular to the channel.

10. A stamping apparatus in accordance with claim 5, wherein the lower housing half die includes a raised stamping surface having a substantially rectangular shape.

11. A stamping apparatus in accordance with claim 10, wherein the raised stamping surface includes an inclination.

12. A stamping apparatus in accordance with claim 11, wherein the inclination from the center to the edge of the raised stamping surface is from about 0.05 mm to about 0.01 mm.

13. A stamping apparatus in accordance with claim 5, including a severing unit to cut off a rocker pressure member at an embossed section of the shaped wire.

14. A rocker pressure member for a chain hinge joint of a plate-link chain, said rocker pressure member comprising: an elongated connecting member for joining link plates of a plate-link chain, the connecting member including contact surfaces along one longitudinal side for contacting an inner edge of an opening formed in a link plate, and including a rolling surface along an opposite longitudinal side of the connecting member, wherein at least the rolling surface of the connecting member is embossed in a stamping operation to form a rocker pressure member.

15. A rocker pressure member in accordance with claim 15, wherein the rocker pressure member includes a reduced depth region lying between the rolling surface and the contact surfaces.
